(19) United States
(12) Patent Application Publication
(10) Pub. No.: US 2022/0128837 A1
(43) Pub. Date: Apr. 28, 2022

(54) CORRECTING POSTURE EYEGLASSES

(71) Applicants: WITWOT INC., Syracuse, NY (US); Clear Electron Co., Ltd., Tokyo (JP)

(72) Inventor: Yi WANG, Beijing (CN)

(21) Appl. No.: 17/376,672

(22) Filed: Jul. 15, 2021

(30) Foreign Application Priority Data
Oct. 27, 2020 (JP) 2020-179809

(51) Int. Cl. G02C 5/14; G02C 11/00

(52) U.S. Cl. CPC G02C 5/146; G02C 11/10

(57) ABSTRACT

A correcting posture eyeglasses includes lenses, a lens holding frame holding the lenses, and two leg portions hingedly connected to both sides of the lens holding frame. One leg portion has a hollow housing portion in which a circuit board is accommodated, and the hollow housing portion comprises a housing case having a shape of a bottom-opened box type in which an opening is formed in a bottom wall, and a cover portion for closing the opening. An inner surface of the cover portion is provided with a projecting portion facing the top wall of the housing case, and a part of a connecting seat for hinge connection with one side of the lens holding frame is embedded in the projecting portion.

### CROSS-REFERENCE TO RELATED APPLICATIONS

This application claims priority of Japanese Patent Application No. JP 2020-179809 filed on Oct. 27, 2020, the contents of which are incorporated herein.

### TECHNICAL FIELD

The present disclosure relates to a correcting posture eyeglasses.

### BACKGROUND ART

CN207037259U discloses a correcting posture eyeglasses having a lens holding frame that holds a pair of lenses, and a pair of leg portions which are respectively hinged to both sides of the lens holding frame. A battery, a control unit, a semiconductor chip, a communication module, and any other devices are embedded in the leg portions in the eyeglasses.

### SUMMARY OF DISCLOSURE

However, according to the correcting posture eyeglasses described in CN207037259A, the leg portions are formed as a hollow shape in which the battery, the control unit, the semiconductor chip, the communication means, and any other devices are embedded. Furthermore, a connecting seat for a hinged connection with the lens holding frame is mounted to the hollow leg portions. With the configuration described above, it is difficult to enhance a stability for the attachment of the connecting seat to the leg portion.

The present disclosure has been made to solve the problem described above, and an object thereof is to provide a correcting posture eyeglasses which enhances the stability for the attachment of a connecting seat to a leg portion.

According to one aspect of a present disclosure, a correcting posture eyeglasses comprising: lenses; a lens holding frame holding the lenses; two leg portions hingedly connected to both sides of the lens holding frame; wherein at least one of the two leg portions has a hollow housing portion in which a circuit board is accommodated, and the housing portion comprises a housing case having a shape of a bottom-opened box type in which an opening is formed in a bottom wall, and a cover portion for closing the opening, an inner surface of the cover portion is provided with a projecting portion facing a top wall of the housing case, and a part of a connecting seat for hinged connection with one side of the lens holding frame is embedded in the projecting portion.

The aspect of the present disclosure improves the stability for the attachment of the connecting seat to the leg portions.

### BRIEF DESCRIPTION OF DRAWINGS

FIG. 1 is a perspective view showing a correcting posture eyeglasses according to an embodiment of the present disclosure.

FIG. 2 is a plan view showing the correcting posture eyeglasses according to the embodiment of the present disclosure.

FIG. 3 is an enlarged cross-sectional schematic view showing a part A in FIG. 2.

FIG. 4 is a schematic diagram showing a right leg portion.

### DETAILED DESCRIPTION OF PREFERRED EMBODIMENTS

An embodiment of the present disclosure will be described with reference to the drawings. Same configuration elements are denoted by the same reference numerals in this description.

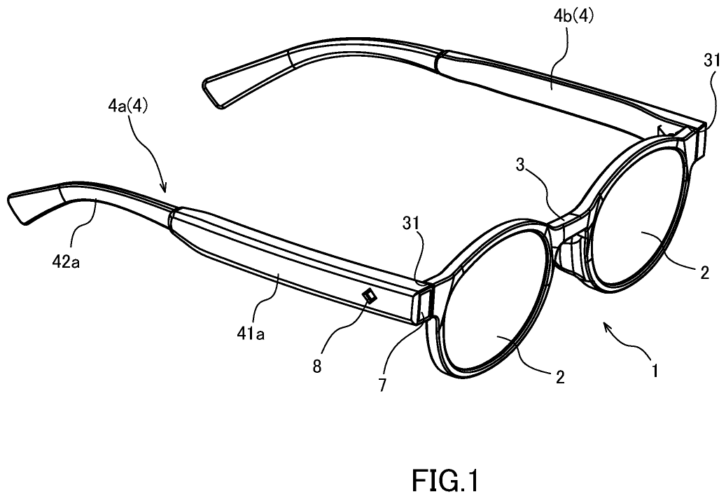

A configuration of a correcting posture eyeglasses 1 according to the present embodiment will be described with reference to FIG. 1 to FIG. 4.

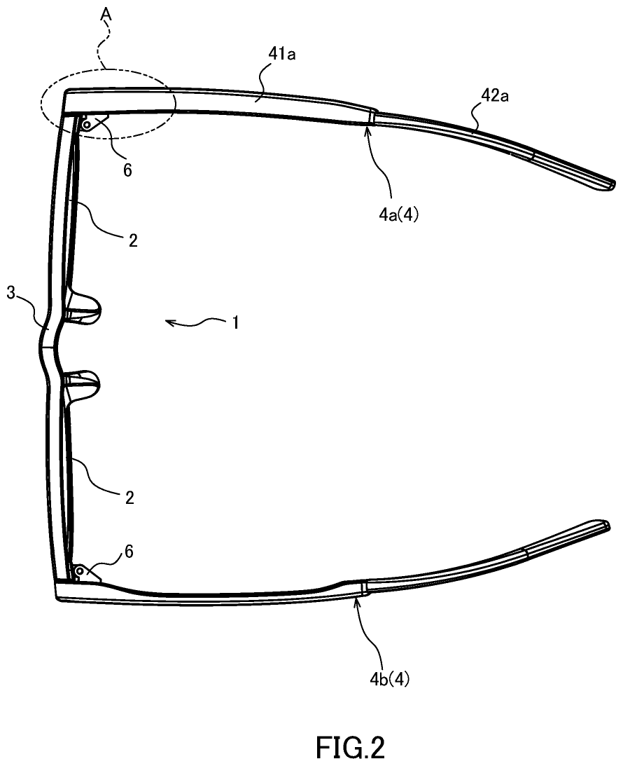

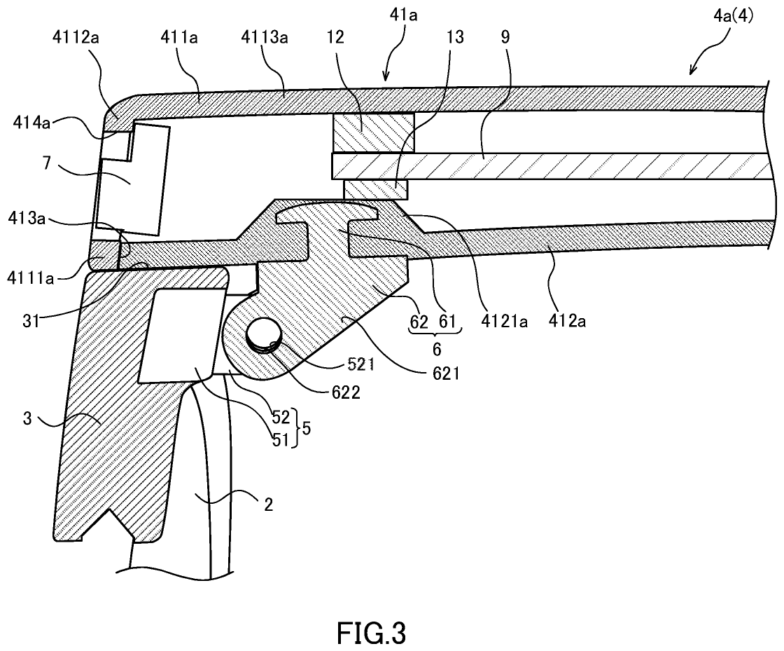

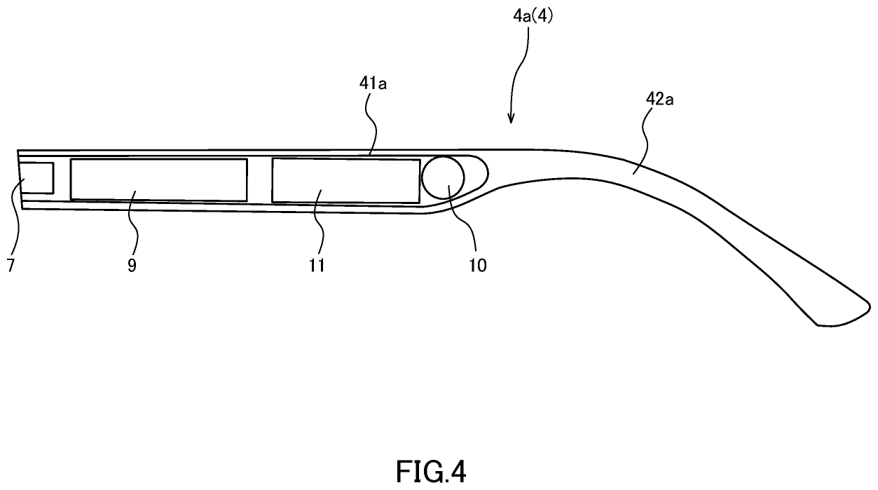

FIG. 1 is a perspective view showing the correcting posture eyeglasses 1 according to the embodiment of the present disclosure. FIG. 2 is the plan view showing the correcting posture eyeglasses 1 according to the embodiment of the present disclosure. FIG. 3 is the enlarged cross-sectional schematic view showing the part A in FIG. 2. FIG. 4 is the schematic diagram showing the right leg portion.

As shown in FIG. 1 and FIG. 2, the correcting posture eyeglasses 1 according to the present embodiment is a smart eyeglasses that detects an improper posture by analyzing obtained parameters. The smart eyeglasses notifies a warning for prompting the user to correct the user's posture, when the posture is not proper. An example of the user's posture is a sitting posture. The correcting posture eyeglasses 1 includes a pair of lenses 2, a lens holding frame 3, and two leg portions 4.

The lenses 2 correct defective visions of the user. The lenses 2 may be constituted of a glass material, or may be constituted of a resin material, if necessary. The lenses 2 which do not correct the visions of the user are applicable.

The lens holding frame 3 is a frame for holding the lenses 2. Further, the lens holding frame 3 is made of a resin material, such as polyamide or polycarbonate. As shown in FIG. 3, a pair of mounting seats 5 for hinged connection with the leg portions 4 are provided in the both ends of the lens holding frame 3. Furthermore, a pair of rotation restricting wall surfaces 31 which extend along the vertical direction are formed on the edges at the both sides of the lens holding frame 3. Each rotation restricting wall surface 31 is a wall surface for restricting an excessive external rotation of the leg portion 4 and positioning the leg portion 4 in the use state (spread state) of the correcting posture eyeglasses 1.

The mounting seat 5 is a seat portion for hinged connection between the lens holding frame 3 and each leg portion 4. The mounting seat 5 is constituted by a metal material such as titanium alloy. With the configuration described above, the required strength for the hinged connection is ensured. Further, each mounting seat 5 has a buried portion 51 (see FIG. 3) and a mounting seat main body 52. The buried portion 51 is embedded in a side of the lens holding frame 3, and the mounting seat main body 52 is exposed from both sides of the lens holding frame 3. A shaft hole 521 is formed to penetrate the mounting seat main body 52 along the vertical direction.

In the present embodiment, the lens holding frame 3 is made of the resin material, but is not limited thereto. The lens holding frame 3 may be made of a metal material such as titanium alloy, for example. In this configuration, the mounting seat 5 is composed of only the mounting seat main body 52, but is not limited thereto. The lens holding frame 3 and the pair of mounting seats 5 may be integrally formed.

The two leg portions 4 are hingedly connected to both sides of the lens holding frame 3. The two leg portions 4 are made of the resin material, such as polyamide or polycarbonate, for example. The pair of mounting seats 5 and a pair of connecting seats 6 for hinged connection with the mounting seats 5 are provided at the front-end side of the pair of leg portions 4 respectively. The pair of mounting seats 5 are disposed at both ends of the lens holding frame 3. The two leg portions 4 are composed of a right leg portion 4a as one of the leg portions, and a left leg portion 4b as another of the leg portions.

The leg portion 4b on the left is molded by the resin material such that the leg portion 4b is solid.

As shown in FIG. 4, the right leg portion 4a includes a hollow housing portion 41a, and a solid ear rest portion 42a. The ear rest portion 42a is connected to a rear end as one end of the housing portion 41a.

As shown in FIG. 1 and FIG. 4, a distance detection sensor 7, a light detection sensor 8, a circuit board 9, a speaker 10 as a notification means, and the battery 11 are provided in the housing portion 41a. The light detection sensor 8 and the circuit board 9 are examples of detecting units.

The distance detection sensor 7 is a sensor for detecting a distance from the user (the correcting posture eyeglasses 1) to a target object (for example, a book, a smartphone, a television, a monitor, or the like). In the present embodiment, the distance detection sensor 7 is constituted by a laser distance detection sensor, but is not limited thereto. The distance detection sensor 7 may obtain the distance by converting a time elapsing from a transmission to a receipt of the laser beam. For example, the distance detection sensor 7 may be constituted by an ultrasonic distance detection sensor. The distance detection sensor 7 is provided at the front end, which is the other end of the housing portion 41a.

The light detection sensor 8 is a sensor for detecting a light intensity in an external environment. The light detection sensor 8 is provided at the side of a top wall 4113a of the housing portion 41a.

The circuit board 9 is provided behind the distance detection sensor 7 so as to be adjacent to the distance detection sensor 7. A control unit (CPU/not shown in figures) is mounted in the circuit board 9 and the control unit programmed to control the correcting posture eyeglasses 1. The control unit is constituted by a microcomputer, for example. Furthermore, the control unit determines whether the user's posture is proper or not based on the detected values output from the distance detection sensor 7 and the light detection sensor 8. If the user's posture is determined to be improper, the control unit generates a notification command and output the command to the speaker 10.

The speaker 10 generates a warning sound in response to the notification command output from the control unit such that the user is prompted to correct the posture. The speaker 10 is provided on the rear end side of the housing portion 41a. In the present embodiment, the notification means is configured by the speaker 10, but is not limited thereto. The notifying means may be configured by a vibrator, for example.

The battery 11 is a power supply for supplying electric power to the distance detection sensor 7, the light detection sensor 8, the circuit board 9, the speaker 10. The battery 11 is arranged between the circuit board 9 and the speaker 10.

As mentioned above, the distance detection sensor 7, the light detection sensor 8, the circuit board 9, the speaker 10 and the battery 11 are integratedly arranged in the housing portion 41a of the right leg portion 4a. Therefore, it is possible to make electrical wiring easier and significantly reduce the manufacturing cost in comparison with an eyeglasses in which the distance detection sensor 7, the light detection sensor 8, the circuit board 9, the speaker 10 and the battery 11 are distributedly arranged in the separate parts (specifically, the lens holding frame 3 and two legs 4). In addition, when one/some part(s) of the eyeglasses is/are broken, it is necessary to replace the broken part(s) only. Therefore, it is also possible to reduce the maintenance cost for the user.

In the present embodiment, the distance detection sensor 7, the light detection sensor 8, the circuit board 9, the speaker 10 and the battery 11 are accommodated in the housing portion 41a, but are not limited thereto. For example, in addition to these components, a sensor for temperature for detecting a temperature and/or a sensor for humidity for detecting a humidity may be accommodated. A communication device for communicating with other electronic devices may be accommodated. With the configuration described above, it is possible for the control unit to execute the determination more accurately.

The housing portion 41a includes a housing case 411a and a cover portion 412a.

In this embodiment, the housing case 411a is integrally molded with the ear rest portion 42a, but is not limited thereto. The housing case 411a may be formed separately from the ear rest portion 42a, for example.

The housing case 411a is a case having a shape of a bottom-opened box type, which is a type of box having an opening in the bottom, specifically an opening 413a is formed in a bottom wall 4111a. A window portion 414a is formed in a front wall 4112a of the housing case 411a for exposing the distance detection sensor 7.

A mounting base 12 as a mounting portion is fixed to the top wall 4113a of the housing case 411a. Specifically, the mounting base 12 is fixed to the inner surface of the top wall 4113a, and the top wall 4113a faces the cover portion 412a. The circuit board 9 is fixed to the top wall 4113a via the mounting base 12. The top wall 4113a is separated from the lens holding frame 3 in either the use state (spread state) of the correcting posture eyeglasses 1 or the non-use state (folded state) of the correcting posture eyeglasses 1.

The cover portion 412a is formed in a shape of a plate. The cover portion 412a closes the opening 413a of the housing case 411a by screw tightening, for example. The cover portion 412a faces the lens holding frame 3 in either the use state (spread state) or the non-use state (folded state) of the correcting posture eyeglasses 1.

The outer surface of the cover portion 412a faces back from the top wall 4113a. The outer surface of the cover portion 412a abuts against the rotation restricting wall surface 31 in the use state (spread state/refer to FIG. 3) of the correcting posture eyeglasses 1. With the configuration described above, the rotation of the right leg portion 4a is regulated so that the right leg portion 4a is positioned.

As described above, in the use state of the correcting posture eyeglasses 1, the rotation restricting wall surface 31 located at the side edge of the lens holding frame 3 abuts the outer surface of the cover portion 412a of the leg portion 4a, and the abutment positions the leg portion 4a. With the configuration described above, the front end of the housing portion 41a of the leg portion 4a (specifically, the front wall 4112a of the housing case 411a) can be exposed without being obstructed by the lens holding frame 3. The distance detection sensor 7 can be provided on the front end of the housing portion 41a of the leg portion 4a, not in the lens holding frame 3. Therefore, it becomes easier to provide the electric wire to electrically connect the distance detection sensor 7 and the circuit board 9.

The connecting seat 6 is arranged in the cover portion 412a. The connecting seat 6 is constituted by a metal material such as titanium alloy, for example. This ensures the required strength for the hinge connection. The connecting seat 6 has an anchor portion 61 as a part embedded in the front-end side of the cover portion 412a, and a connecting seat main body 62 exposed from the cover portion 412a. The connecting seat main body 62 has a pair of sandwiching pieces 621 for sandwiching the mounting seat main body 52 from the vertical direction. A gap for inserting the mounting seat main body 52 is formed between the pair of sandwiching pieces 621. Furthermore, a shaft axial hole 622 is formed in the pair of sandwiching pieces 621 by penetrating in the vertical direction.

In a state where the mounting seat main body 52 is sandwiched by the pair of sandwiching pieces 621, the connecting shaft (not shown in figures) is inserted into the shaft hole 521 formed in the mounting seat main body 52 and the shaft hole 622 formed in the sandwiching piece 621. With the configuration described above, the mounting seat 5 and the connecting seat 6 can be hingedly connected easily.

The cover portion 412a is provided with a projecting base 4121a as a projecting portion. The projecting base 4121a is a protruded part facing the top wall 4113a of the housing case 411a. The anchor portion 61 of the connecting seat 6 is embedded in the projecting base 4121a. With such configuration, it is possible to improve the stability for the attachment of the connecting seat 6 to the cover portion 412a as compared with a case where the anchor portion 61 is not embedded in the projecting base 4121a. The cover portion 412a is the housing portion 41a of the leg portion 4a.

The projecting base 4121a is integrally molded with the cover portion 412a by the resin material. As described above, the anchor portion 61 of the connecting seat 6 can be reliably sealed in the projecting base 4121a. The projecting base 4121a is separated from the top wall 4113a of the housing case 411a. Therefore, a gap is formed between the projecting base 4121a and the top wall 4113a.

The spacer 13 is sandwiched between the projecting base 4121a of the cover portion 412a and the circuit board 9. Therefore, the spacer 13 is provided so that one side surface and another side surface thereof are in contact with the top surface of the projecting base 4121a and one surface of the circuit board 9, respectively. With the configuration described above, the projecting base 4121a in which the anchor portion 61 is embedded is supported on the top wall 4113a of the housing case 411a by the spacer 13, the circuit board 9, and the mounting base 12. Therefore, it is possible to further improve the stability for the attachment of the connecting seat 6 to the housing portion 41a of the leg portion 4a.

While an electrical wire (not shown in figures) is provided for electrically connecting the distance detection sensor 7 and the circuit board 9, and the electrical wire passes through a gap between the projecting base 4121a and the top wall 4113a. With such configuration, the electric wire does not detour to avoid the projecting base 4121a like in a case where the gap is not formed between the projecting base 4121a and the top wall 4113a. Therefore, the electric wire can be easily provided in the gap between the projecting base 4121a and the top wall 4113a.

In the following, the operation and effect of the present embodiment will be described.

According to the present embodiment, the correcting posture eyeglasses 1 has: the lenses 2; the lens holding frame 3 holding the lenses 2; two leg portions 4 hingedly connected to both sides of the lens holding frame 3. The right leg portion 4a has the hollow housing portion 41a in which the circuit board 9 is accommodated. The hollow housing portion 41a includes a housing case 411a having a shape of a bottom-opened box type in which the opening 413a is formed in the bottom wall 4111a and the cover portion 412a for closing the opening 413a. The inner surface of the cover portion 412a is provided with the projecting base 4121a facing the top wall 4113a of the housing case 411a. The anchor portion 61 of the connecting seat 6 hingedly connected to the right side of the lens holding frame 3 is embedded in the projecting base 4121a.

According to this configuration, the anchor portion 61 of the connecting seat 6 is embedded in the projecting base 4121a of the cover portion 412a. With the configuration described above, it is possible to improve the stability for the attachment of the connecting seat 6 to the cover portion 412a of the housing portion 41a of the leg portion 4a, as compared with a case where the anchor portion 61 is not embedded in the projecting base 4121a.

In the present embodiment, the circuit board 9 is fixed to the top wall 4113a via the mounting base 12, and the spacer 13 is sandwiched between the projecting base 4121a and the circuit board 9.

According to this configuration, the projecting base 4121a in which the anchor portion 61 is embedded is supported by the spacer 13, the circuit board 9, and the mounting base 12 on the top wall 4113a of the housing case 411a. Therefore, it is possible to improve the stability for the attachment of the connecting seat 6 to the housing portion 41a of the leg portion 4a.

In the present embodiment, the right leg portion 4a further includes the solid ear rest portion 42a connected to the one end of the housing portion 41a, and another end of the housing portion 41a is provided with the distance detection sensor 7 for detecting the distance from the user (the correcting posture spectacles 1) to the target object. The electric wire for electrically connecting the distance detection sensor 7 and the circuit board 9 passes through the gap between the projecting base 4121a and the top wall 4113a.

With the configuration described above, the electric wire does not detour to avoid the projecting base 4121a like in the case where a gap is not formed between the projecting base 4121a and the top wall 4113a. Therefore, the electrical wire can be easily provided in the gap between the projecting base 4121a and the top wall 4113a.

In the present embodiment, the cover portion 412a and the projecting base 4121a are integrally molded of the resin material.

With the configuration described above, the anchor portion 61 of the connecting seat 6 can be reliably sealed in the projecting base 4121a.

Although the present embodiment and modifications have been described above, the above-mentioned embodiments and modifications are merely examples of application of the present disclosure, and the technical scope of the present disclosure is not intended to be limited to the specific configurations of the above-mentioned embodiments.

1. A correcting posture eyeglasses comprising:
lenses;
a lens holding frame holding the lenses;
two leg portions hingedly connected to both sides of the lens holding frame;
wherein at least one of the two leg portions has a hollow housing portion in which a circuit board is accommodated, and the housing portion comprises a housing case having a shape of a bottom-opened box type in which an opening is formed in a bottom wall, and a cover portion for closing the opening,
an inner surface of the cover portion is provided with a projecting portion facing a top wall of the housing case, and
a part of a connecting seat for hinged connection with one side of the lens holding frame is embedded in the projecting portion.

2. The correcting posture eyeglasses according to claim 1, wherein
the projecting portion is spaced from the top wall.

3. The correcting posture eyeglasses according to claim 1, wherein
the circuit board is fixed to the top wall via a mounting portion, and
a spacer is sandwiched between the projecting portion and the circuit board.

4. The correcting posture eyeglasses according to claim 2, wherein
at least one of the leg portions further comprises a solid ear rest portion connected to one end of the housing portion,
a detection unit configured to detect a predetermined parameter is provided at another end of the housing portion,
an electrical wire for electrically connecting the detection unit and the circuit board passes through a gap between the projecting portion and the top wall.

5. The correcting posture eyeglasses according to claim 1, wherein
the connecting seat is made of a metal material, and
the cover portion and the projecting portion are integrally formed of a resin material.
